(19) United States
(12) Patent Application Publication
(10) Pub. No.: US 2007/0150316 A1
(43) Pub. Date: Jun. 28, 2007

(54) Discovering billable health care plans

(76) Inventors: Jason Sanner, Painesville, OH (US); Gerald Anguilano, Strongsville, OH (US); Frank Gritti, Strongsville, OH (US); Robert Lehmann, Chagrin Falls, OH (US)

Correspondence Address: FAY SHARPE LLP, 1100 SUPERIOR AVENUE, SEVENTH FLOOR, CLEVELAND, OH, 44114, US

(21) Appl. No.: 11/642,809

(22) Filed: Dec. 20, 2006

Related U.S. Application Data
(60) Provisional application No. 60/753,570, filed on Dec. 23, 2005.

(51) Int. Cl. G06F 19/00; G06Q 40/00

(52) U.S. Cl. 705/3; 705/4

(57) ABSTRACT

A method for discovering billable health plan enrollment for a patient includes receiving patient information for one or more patients from a medical service provider. The patient information is analyzed, and a sample of patients and a sample of health care plans are selected based on the analysis. An enrollment eligibility inquiry is sent to each of the health care plans for each of the patients. Each of the health care plans returns an eligibility response that indicates whether any of the patients are enrolled in any of the health care plans for each inquiry. These results are provided to the medical care provider. In addition, these results, along with any feedback from the medical service provider regarding any claims submitted to the health care plans for the enrolled patients, and used to refine the analysis of the patient information for subsequent health care enrollment searches.

### CROSS-REFERENCE TO RELATED APPLICATION

This application claims priority from and benefit of the filing date of U.S. Provisional Application Ser. No. 60/753,570 filed Dec. 23, 2005 (Dec. 23, 2005), the disclosure of which is hereby expressly incorporated by reference.

### BACKGROUND

The following relates to systems and methods that facilitate reimbursing medical service providers for medical services rendered to patients. It finds particular application to discovering previously unknown health care plan enrollment in health care plans that may contribute to a balance due for the medical services.

Advances in the electrical, electronic, computer, and networking technologies have led to low-cost, powerful computing entities that have pervaded essentially all aspects of day-to-day living. For instance, every day computers are used for executing financial transactions (e.g., banking, investment, purchases, etc.), communication (e.g., email, instant messaging, etc.), entertainment (e.g., television, etc.), household chores (e.g., cooking, laundry, heating/cooling, etc.), etc. Many of these examples include uni-directionally and/or bi-directionally conveying information in an electronic format. For example, a typical on-line banking session may include electronically providing an account username and password and instructions for transferring funds, viewing statements, paying creditors, etc.

In some instances, the government has enacted legislation that encourages and promotes the use of electronic data. For example, Congress enacted the Health Insurance Portability and Accountability Act (HIPAA) in which Title II of the Act, the Administrative Simplification (AS) provisions, requires the establishment of national standards for electronic health care transactions and national identifiers for providers, health insurance plans, and employers. The AS provisions also address the security and privacy of health data. The standards are meant to improve the efficiency and effectiveness of the nation's health care system by encouraging the widespread use of electronic data interchange in health care.

The AS provisions are applicable to “covered entities,” which include health care providers (e.g. doctors offices and hospitals) that engage in electronic transactions subject to the HIPAA Electronic Data Interchange (HIPAA/EDI) rules, health plans (which includes health insurance companies and employer-sponsored “group health plans”), and health care clearinghouses. The HIPAA/EDI rules define standards for electronic transactions, including, but not limited to, ANSI 270 and ANSI 271, which respectively provide standards for health care eligibility inquires and responses thereto.

Using these standards, a health care provider can electronically inquire into the health care enrollment of a patient with a particular health care plan. By way of example, the health care provider can electronically submit a 270 inquiry to a clearinghouse regarding the eligibility of the patient for the particular health care plan. The clearinghouse communicates the electronic inquiry to the specified health care plan. In response, the health care plan returns a 271 response, which is provided to the inquiring health care provider. The 271 response indicates whether the patient is covered under that particular health care plan and, thus, whether the health care provider can submit a claim for payment to the health care plan.

One approach to identifying additional health care plans include submitting 271 inquiries to virtually all known health care plans. However, a typical clearinghouse charges a fee for each 270 inquiry, and a different 270 inquiry is created and submitted for each health care plan. Thus, the cost of the total inquiry is directly proportional to the number of 270 inquiries submitted, or the number of health care plans. Considering that there may be thousands of health care plans at any given time, this approach tends to be cost prohibitive since the medical service provider may end up losing money and/or not achieving a desired profitability. Thus, there is an unresolved need to efficiently locate potential health care plans to help pay medical service providers for medical services at a reasonable cost.

### SUMMARY

In one aspect, a method for discovering billable health plan enrollment for a patient is illustrated. The method includes receiving patient information for one or more patients from a medical service provider. The patient information is analyzed, and a sample of patients and a sample of health care plans are selected based on the analysis. An enrollment eligibility inquiry is sent to each of the health care plans for each of the patients. Each of the health care plans returns an eligibility response that indicates whether any of the patients are enrolled in any of the health care plans for each inquiry. These results are provided to the medical care provider. In addition, these results, along with any feedback from the medical service provider regarding any claims submitted to the health care plans for the enrolled patients, and used to refine the analysis of the patient information for subsequent health care enrollment searches.

### BRIEF DESCRIPTION OF THE DRAWINGS

FIG. 1 illustrates an exemplary method for discovering billable health care plans;

FIG. 2 illustrates another exemplary method for discovering billable health care plans; and

FIG. 3 illustrates an exemplary system for implementing the methods described in connection with FIGS. 1 and 2.

### DETAILED DESCRIPTION

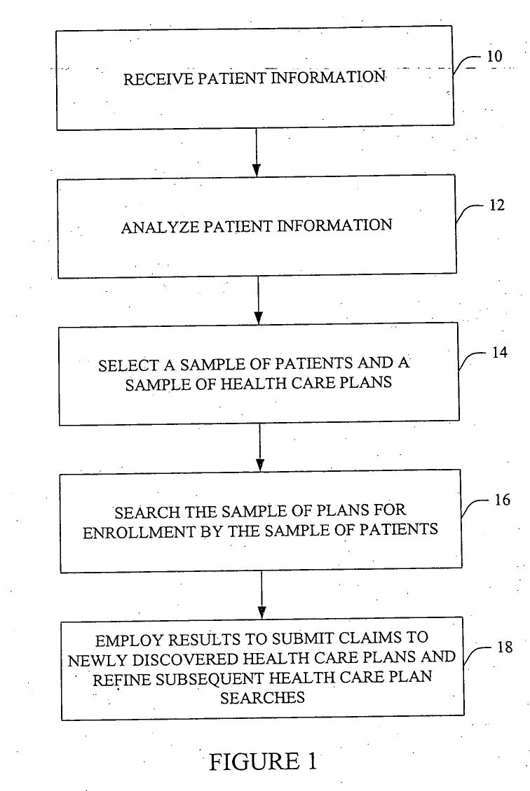

With reference to FIG. 1, a method for discovering billable health care plans (e.g., health insurance companies, etc.) is illustrated. At reference numeral 10, patient information is received from one or more medical service providers (e.g., a hospital, a clinic, a practitioner, etc.) interested in discovering health care plan enrollment in addition to already known health care plan enrollment. The patient information can be provided in an electronic format such as an electronic file that can be stored, viewed, edited, processed, read, written, etc. within a computing system such as a computer (e.g., mainframe, desktop, laptop, hand held, etc). Delivery of the electronic patient information can be through a physical storage medium such as CD, DVD, optical disk, floppy disk, memory stick, etc. or connections such as Ethernet, USB, Firewire, IR, RS-232, etc. using various protocols such as FTP, HTTP, etc. Alternatively, the patient information can be provided in a handwritten, typed, vocal, etc. format. In this case, the patient information can be entered into an electronic format. For example, the information can be manually entered into an electronic file through use of a keyboard, a keypad, a microphone, a digital pen, a touch screen, a mouse, and/or other computer based input devices. In another example, the paper document can be scanned to produce an electronic version. The electronic patient information typically is delineated by medical service provider, sub-delineated by patient for each medical service provider, and subsequently stored along with any previously received patient information and/or associated information such as scores, results, etc. from previous searches.

At 12, the patient information is analyzed. It is to be appreciated that various types of analysis can be performed on the patient information. For instance, the analysis can include a statistical analysis that includes heuristics, probabilities, historical data (e.g., results from previous searches for new billable health care plans), inferences, explicitly and/or implicitly trained classifiers (including support vector machines, neural networks, expert systems, Bayesian belief networks, fuzzy logic, data fusion engines, etc.), etc. The analysis can additionally or alternatively include scoring (e.g., assigning relative weights, probabilities, etc.) and/or evaluating the patient information, medical service providers, and/or health care plans based on various criteria. At 14, a sample of patients associated with a medical service provider is selected based on the analysis, and a sample of health care plans to search is selected based on the analysis. Typically, the samples are selected such that the sample of patients represents patients with a relatively high likelihood of having additional previously unknown health plan enrollment discovered and profitably billed. The sample of health care plans represents the health plans with a relatively high likelihood of having financial liability for the patients.

At 16, each of the health care plans in the sample is checked to determine whether any of the patients in the sample is enrolled therein. In some instance, the sample of patients and/or health care plans is further reduced prior to such check. This may include submitting electronic inquiries to each of the health care plans and receiving electronic responses from each of the health care plans. The results are sent to the medical service providers who can use this information to submit claims to the newly identified health care plans. At 18, the responses to the newly submitted claims (e.g., any additional monies collected, etc.) are used to determine whether any claims should be submitted to the newly discovered health care plans. In addition, the results are used to update the patient information and then used to determine whether another sample of patients and/or health care plans should be selected for another iteration and/or upon performing another search for the medical service provider.

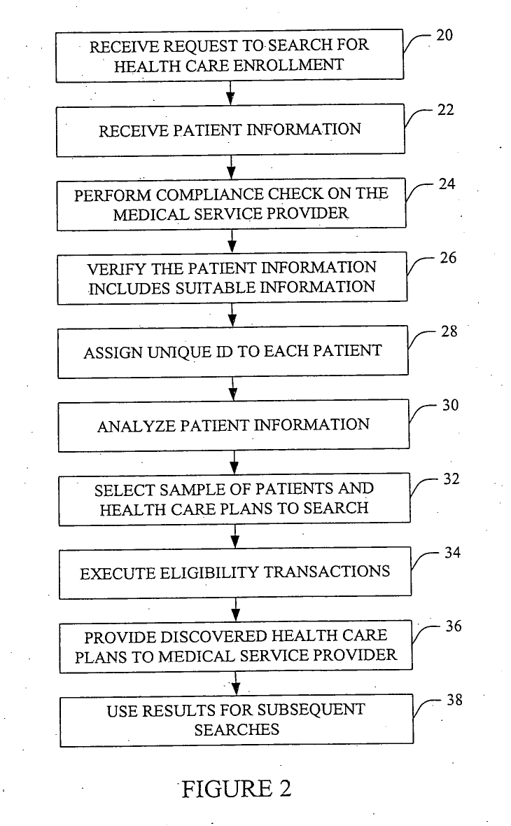

FIG. 2 illustrates another method for discovering billable health care plans. At reference numeral 20, a request from a medical service provider to search for patient enrollment in one or more health care plans for a patient is received. It is to be appreciated that the request can be through a subscription to such service and/or on an on-demand basis and will not fulfilled unless the medical service provider is authorized. The request typically involves locating previously unknown enrollment in health care plans that may contribute to paying the medical service provider for medical treatment rendered to the patient. Such request may be made when the known health care plan(s) covering the patient does not pay the full cost of the medical treatment or when the patient asserts to have no health care insurance. Other criteria can also be used to determine whether to request such information. For instance, the cost (e.g., fees, time, resources, etc.) of the search may be considered when determining whether to request such information. For example, where the cost to locate enrollment in additional health care plans is greater than the balance due, the medical service provider may determine not to initiate such search. However, where the cost to locate enrollment in additional health care plans is nominal relative to the balance due, the medical service provider may determine to initiate such search.

At 22, patient information for the patient is received from the medical service provider. As described above, the patient information can be provided in an electronic format or converted to an electronic format. At 24, a compliance check is performed on the medical service provider. For example, the patient information is examined to verify that is was delivered from an authorized medical service provider who has given authorization to use the patient information to search for additional billable health care plans. In one instance, the medical service provider provides authorization pursuant to the disclosure of electronic private health information as defined under the Health Insurance Portability and Accountability Act (HIPAA) of 1996. If such authorization is not present, then the patient information can be discarded, returned to the sender, etc. In other instances, suitable authorization may be determined based on other governmental legislation and/or private policies.

At reference numeral 26, the patient information is examined to determine whether suitable information has been provided. Examples of suitable information include, but are not limited to, patient demographics (e.g., full legal name, date of birth, address, zip code, etc.), health care subscriber demographics for the subscriber of the health insurance plan covering the patient, a relationship between the patient and the subscriber (e.g., self, child, spouse, dependent, etc.), a name of the health care plan covering the patient, an identification number for the subscriber within the health care plan, a date of service of the medical treatment, and a cost of the medical treatment. If the patient information does not include suitable information, the patient information can simply be discarded or returned to the medical service provider, or the medical care provider can be apprised of any missing information and given the opportunity to provide such information.

If the medical service provider is an authorized provider and the patient information includes suitable information, then at reference numeral 28 the patient information is assigned a unique identification number and stored. Typically, the stored patient information is delineated by medical service provider and further delineated under each medical service provider by patient. In one instance, the patient information from each medical service provider is stored in separate databases residing within one or more virtual or physical machines such that each database is unique to a medical service provider. In another instance, all of the patient information is stored within separate and/or isolated storage areas within a single storage component. In other instances, the patient information from one or more different medical service providers is commingled (e.g., when a hospital system comprises more than one medical service provider and other criteria such as number of beds, location, etc. is met).

At 30, the patient information for each patient for each medical service provider is analyzed, as described above, using various types of analysis schemes. The analysis can be performed on the medical service provider and/or the patient information. For example, information about the medical service provider can be analyzed to compute a billing frequency for the medical service provider by ranking all of the health care plans billed by the medical service provider by percentage billing (e.g., health care plan X was billed 25% of the time, health care plan Y was billed 15% of the time, etc.). Such billing frequency can be used to create a billing frequency table or the like. In another example, the medical service provider is scored based on profitability, or the technique used to determine financial liability for medical services provided. For instance, the contract between the medical service provider and the health care plan may recite a formula such as 80% or 120% of what a government sponsored health insurance plan pays. In another instance, the medical service provider may be a secondary plan that pays at least a portion of the balance (e.g., as a percentage, a flat rate, the difference, etc.) after payment from a primary plan. In general, health care plans that pay more are assigned a higher score since they are more likely to be profitably billed. Various other scoring, including more or less or similar or different scoring, can be performed on the medical service provider.

Examples of scoring patient information include, but are not limited to, assigning one or more scores to each patient record based on one or more of the following: a billed amount of a claim; the health care plan that was billed; a zip code of the patient; an age (or range of ages) of the patient, etc. and/or a multi-variant scores based on one or more combinations of the aforementioned scores and/or other information (e.g., a score may be assigned for the combination of age and payer, etc.). In addition to the above, an average billed amount of the claim can be calculated for all of the records. This can be done as an aggregate over all patients and/or within various tiers. For instance, an average claim for claims over one thousand dollars can be computed, an average claim for claims over three thousand dollars can be computed, an average claim for claims over five thousand dollars can be computed, etc. The various tiers used are based on characteristics of the medical service provider such as the type of procedures performed, the cost of such procedures, etc. Further, patient information and/or scores from previous searches for the medical service provider can be used in connection with the above information to update and/or compute more scores.

At 32, a sample of patients and a sample of health care plans to search is selected. The sample of patients selected are going to be checked for additional presently unknown health care enrollment and the sample of health care plans are the plans that are going to be checked. The selection of the patients can be based on the scoring scheme employed. For example, the average billed amount in the different tiers can be searched to locate a group of patients with a high average claim value. This may be from one or more tiers, exclude patients covered by one or more particular health care plans, etc. In one instance, this sample represents patients with a relatively high likelihood (e.g., a likelihood surpassing a threshold level) of having additional previously unknown health plan enrollment discovered and profitably billed. Likewise, the sample of health care plans can be based on the scoring scheme employed. For example, the frequency billing table, contract scores, etc. can be used to select the sample of health care plans to search. In one instance, this sample may represent the health plans with a relatively high likelihood (e.g., a likelihood surpassing a threshold level) of having financial liability for the patients. It is to be appreciated that the sample of patients and/or the sample of health care plans may be further reduced based on other criteria. For example, in one instance, the samples are reduced to include only the top ten patients and the top ten health care plans.

At 34, electronic eligibility inquiries are sent to the sample of health care plans and electronic eligibility responses are received from the sample of health care plans. In one instance, a HIPPA/EDI 270 transaction is submitted for each patient in the sample of patients to each health care plan in the sample of health care plans, and a HIPPA/EDI 271 transaction is returned by each of the health care plans in response to each 270 inquiry. Although these HIPPA/EDI transactions dictate a particular structure for electronically communicating such information, each health care plan can determine the information that it desires before it will return the response. For example, in one instance, a health care plan may request that an eligibility inquiry include a last name and a date of birth of the patient. Upon receiving such information, the health care plan will perform the eligibility search and return the results. In another example, a health care plan may request more detailed information before it will initiate any search. As a result, the eligibility inquiry for each patient may be unique or at least be different from at least one other inquiry. Upon receiving the eligibility responses, the stored patient information is updated to reflect whether or not each of the patients in the sample of patients is enrolled with each health plan in the sample of health care plans.

At 36, information about the patients for whom new health plan enrollment was found is provided to the inquiring medical service provider and/or third party (e.g., the billing company for the medical service provide, etc.). The results of the search can be used to generate a report or the like that includes various information such as patient demographics, information regarding the newly discovered health plan, etc. The medical service provider or other parties (e.g., billing service for the medical service provider, etc.) can use this information to submit claims to newly discovered health care plans. The results of these claims are used to update the stored patient information. For example, for every claim submitted to the newly identified health care plans, a status (e.g., an “Explanation of Benefits” (EOB)) and/or other information is received and used to update the stored patient information. For instance, the stored balance information can be updated to reflect any additional money collected. In another instance, the billed health care plan information can be updated to reflect any of the newly identified health care plans that received a claim. In another instance, the status may state that a particular health care plan was not billed and/or one or more reasons why the health care plan was not billed. Any or all of this status information can be used to create additional and/or update the scores described above.

At 38, the updated patient information and/or scores provide rich data that can be used to initiate another iteration, or a refined inquiry, for the current search and/or for conducting subsequent searches. Thus, for every search, the results are mined and used to train the system in order to make the results of the next search more profitable. Such profitability is not only based on receiving further monies to cover the balance owed, but also on minimizing the number of eligibility inquires sent since there is a fee associated with each eligibility inquiry. Conventional techniques typically query all the health care providers, which may render the search cost prohibitive since the fee to submit eligibility inquiries may be greater than any amount of monies received.

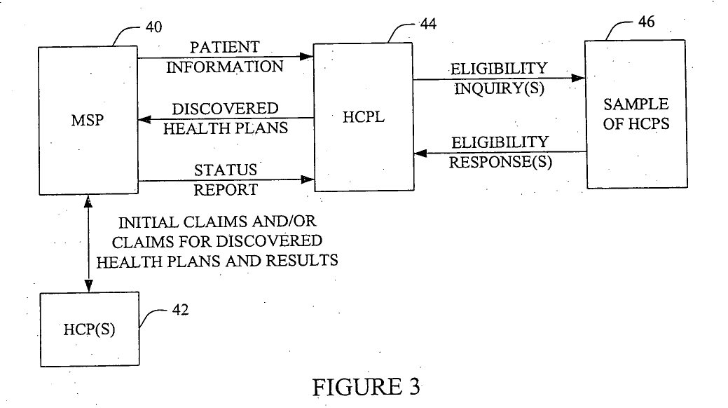

FIG. 3 illustrates a system for implementing the methods described herein and variations thereof for discovering billable health care plans. A medical service provider (MSP) 40 medically treats one or more patients. Each of the patients provides the medical service provider 40 with their health care insurance plan(s) (HCP(s)) 42, if any exists. The medical service provider 40 submits claims to the health care plan(s) 42 of each patient. The health care plan(s) 42, depending on the particular coverage, pays the medical service provider 40. In one instance, where the treatment is not covered by the health care plan(s) 42 of a patient, the medical service provider 40 does not receive any money for the medical treatment. In another instance, where the treatment is fully covered by the health care plan(s) 42 of the patient (e.g., fully covered by one health care plan or through a combination of partial payments from more than one health care plans), the medical service provider 40 receives full payment for the medical treatment. In yet another instance, where the treatment is partially covered by the health care plan(s) 42 of the patients (e.g., partially covered by one health care plan or through a combination of partial payments from more than one health care plans), the medical service provider 40 receives partial payment for the medical treatment.

Depending on the aggregated balance due for medical treatment rendered to one or more patients, the medical service provider 40 may request a search to discover other billable health care plans enrollment that can contribute to paying this balance from a health care plan locator (HCPL) 44. The medical service provider 40 provides the health care plan locator 44 with patient information for the patients with a balance for the medical treatment. As described above, the information can be provided in an electronic format or another format and subsequently converted to an electronic format. In either instance, a secure technique is used to ensure that any confidential information remains confidential. For instance, if the patient information is electronically submitted, the patient information can be encoded, encrypted, password protected, etc. In addition, the transmission protocol and/or channel may be a secure protocol and/or channel.

The health care plan locator 44 checks the medical service provider 40 and validates that the medical service provider 40 is authorized to convey patient information and/or initiate a search for health care plans. As previously discussed, in one instance, the medical service provider 40 must be authorized for the disclosure of electronic private health information as defined under the Health Insurance Portability and Accountability Act (HIPAA) of 1996, while in other instances, suitable authorization may be determined based on other governmental legislation and/or private policies. Additionally, the health care plan locator 44 checks the received patient information to determine whether the received information includes data such as patient demographics, health care subscriber demographics for the subscriber of the health insurance plan covering the patient, a relationship between the patient and the subscriber, a name of the health care plan covering the patient, an identification number for the subscriber within the health care plan, a date of service of the medical treatment, and a cost of the medical treatment. If any of this information is missing, the patient information can be updated or the search request can be ignored.

Upon receiving suitable patient information from an authorized medical service provider 40, the health care plan locator 44 assigns each patient a unique identification. Where patient information for a particular patient has already been stored in connection with a previous health care plan search and assigned a unique identification, the new information is used to update the previously stored information. The foregoing results in a unique identification for each patient. Typically, the patient information for any particular medical service provider is aggregated, for example, within a dedicated database and/or separated from the patient information associated with other medical service providers.

Then health care plan locator 44 analyzes the patient information for each patient for the medical service provider. As discussed above, the analysis can include a statistical analysis that includes heuristics, probabilities, historical data (e.g., results from previous searches for new billable health care plans), inferences, explicitly and/or implicitly trained classifiers (including support vector machines, neural networks, expert systems, Bayesian belief networks, fuzzy logic, data fusion engines, etc.), etc. The results of the analysis may include determining a billing frequency for every health care insurance plan that was billed for a patient for each medical service provider. Such billing frequency can be used to create a billing frequency table or the like. The analysis can also include assigning a score to the patient information based on various criteria. For example, a score can be generated for each billed health plan based on a technique used by each health care plan to determine financial liability for medical services provided and for each patient record based on one or more of the following: a billed amount of a claim; a billed health insurance plan; a zip code of the patient; an age of the patient, etc. and/or a multi-variant scores based on one or more combinations of the aforementioned scores and/or other information. In addition, an average billed amount of the claim can be calculated for all of the records.

Based on the analysis results, the health care plan locator 44 selects a sample of patients and a sample of health care plans that will be searched to determine if any of the patients from the sample of patients is enrolled within any of the health care plans from the sample of health care plans. As noted above, the selection of the patients and the selection of health care plans can be based on the scoring scheme employed, wherein the sample of patients represents patients with a relatively high likelihood (e.g., a likelihood surpassing a threshold level) of having additional previously unknown health plan enrollment discovered and profitably billed and the selection of health care plans represent the health plans with a relatively high likelihood (e.g., a likelihood surpassing a threshold level) of having financial liability for the patients.

The health care plan locator 44 submits electronic eligibility inquires to each of the sample of health care plans 46. As noted above, in one instance, the electronic eligibility inquires include a HIPPA/EDI 270 transaction for each patient in the sample of patients. Since each health care plan may use different information when determining patient eligibility, the eligibility request for any particular patient may be unique. Upon receiving such information, the health care plan will perform the eligibility search and provide one or more electronic eligibility responses, which may include a HIPPA/EDI 271 transaction for each HIPPA/EDI 270 inquiry. The information in the responses is provided to the inquiring medical service provider, which can be used to submit claims to the newly discovered health care plans. In addition, the information is used to update the stored patient information.

Similar to the initial set of service claims, these health care plans either do not pay any of the balance or pay at least a portion of balance or sometimes the entire remaining balance. These results are provided to the health care plan locator 44, which uses the results to update the stored patient information. The results submitted to the health care plan locator 44 may include, as previously discussed, a status report such as an “Explanation of Benefits” (EOB) and/or similar information that provides updated claim status information. For instance, the results may indicated whether any of the balance was collected, the name of newly billed health care plans, demographics of the subscriber of the newly billed health care plans, etc. This new information can be used to determine whether another eligibility inquiry should be submitted for the current search and/or when conducting subsequent searches.

The above methods are described as a series of acts; however, it is to be understood that in alternative instances one or more of the acts can occur in a different order, one or more of the acts can concurrently occur with one or more other acts, and more or less acts can be used. In addition, it will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computing system that discovers billable health plan enrollment for a patient, comprising:
a receiving component that receives patient information for one or more patients from a medical service provider;
an analysis component that analyzes the patient information;
a selection component that selects a set of patients from the patient information based on the analysis and selects a set of health care plans based on the analysis;
a search component that initiates a search of the set of health care plans for enrollment by the set of patients; and
a component that uses the results and a status from the medical service provider regarding their use of the results to refine the analysis of the patient information for subsequent health care enrollment searches.

2. A method for discovering billable health plan enrollment for a patient, comprising:
receiving patient information for one or more patients from a medical service provider;
analyzing the patient information;
selecting a sample of patients and a sample of health care plans based on the analysis;
submitting a health care enrollment eligibility inquiry for each of the patients in the sample of patients to each of the health care plans in the sample the sample;
receiving an eligibility response for each inquiry, the eligibility response indicating whether any of the patients are enrolled in any of the health care plans;
providing the eligibility responses to the medical care provider;
receiving feedback from the medical service provider regarding any claims submitted to the health care plans for the enrolled patients; and
using the eligibility responses and feedback to refine the analysis of the patient information for subsequent health care enrollment searches.

3. A method for discovering billable health plan enrollment for a patient, comprising:
receiving patient information for one or more patients from a medical service provider;
performing a compliance check on the medical service provider;
verifying the patient information includes suitable information;
assigning each patient record within the patient information with a unique identification;
analyzing the patient information;
selecting a sample of patients based on the analysis;
selecting a sample of health care plans based on the analysis;
submitting a health care enrollment eligibility inquiry for each of the patients in the sample of patients to each of the health care plans in the sample the sample;
providing eligibility responses to each eligibility inquiry to the medical care provider, each eligibility response indicates whether the patient is enrolled;
receiving feedback from the medical service provider regarding any claims submitted to the health care plans for the enrolled patients; and
using the eligibility responses and feedback to refine the analysis of the patient information for subsequent health care enrollment searches.

4. A system that discovers billable health plan enrollment for a patient, comprising:
means for receiving electronic patient information for one or more patients from a medical service provider;
means for analyzing the patient information;
means for selecting one or more patients and one or more health care plans based on the analysis;
means for searching the health care plans for enrollment by the patients; and
means for using the results to refine the analysis of the patient information for subsequent health care enrollment searches.
